(19) United States
(12) Patent Application Publication
(10) Pub. No.: US 2022/0395913 A1
(43) Pub. Date: Dec. 15, 2022

(54) DRILL BIT GUIDE

(71) Applicant: GREGORY T. MELARTIN, Spring Valley, MN (US)

(72) Inventor: GREGORY T. MELARTIN, Spring Valley, MN (US)

(21) Appl. No.: 17/347,043

(22) Filed: Jun. 14, 2021

(51) Int. Cl. B23B 47/28

(52) U.S. Cl. CPC B23B 47/284

(57) ABSTRACT

The present invention provides a drill bit guide having a handle and a hollow portion wherein the hollow portion has an open end and another end that includes a socket or set screw useful to separate a bolt head from the shank screw portion for use where access to the shank portion is limited or unavailable. A method of use is further included.

### BACKGROUND

Screws, bolts and lug nuts are expected to be securely and tightly fastened to hold parts of or objects together. In most instances, when these bolts and objects are left in the environment, they get rusted or might become worn out due to the elements or continued use. In other instances, bolts are not accessible from the shank side or even such bolts are loose enough to just be spinning without any grip for unscrewing. In yet some instances, such bolts have on the other end, materials formed on them such as foam or poured insulation, thus preventing access to shank side or any facility to unscrew the bolt or nut. Other fasteners that have in a manner been screwed in without access to the other end, may present a situation wherein unscrewing for any use whatsoever.

Some bolts with shanks are initially fabricated as fasteners for applications and sheeting that may serve the initial fastening purpose only for that desired fastening to be changed or needing to be modified for alternative or modified use. What is common in these instances is a bolt or nut having a shank that is inaccessible for a clamp or some sort of grip that would allow for unscrewing or removal. It is also applicable for bolts and nuts that are not easy to remove, either because they are worn out or even too tight because of rust or the environment.

As shown in the foregoing, a tool such as drill bit guide that secures the bolt while it is drilled would be suitable to remove bolts with shanks in unreachable positions and that would be useful to remove worn out bolts, and the like, is needed and useful for workers and artisans. Such a product is disclosed herein.

### SUMMARY

In one embodiment, the present invention provides a drill bit guide having a handle or grip portion that incorporates a hollow guide suitable for a drill bit on one end and a socket on the second end wherein the socket end fits onto a nut with a bolt head. The use of the drill bit on the nut is centered by the use of the guide and in operation separated the bolt head from a shank portion of the nut.

The drill bit usable in the present invention is preferably used in combination with the guide such that the bit end centers on the bolt head and operating the drill serves to separate the head of the bolt from the shank. The hollow and socket portion of the drill bit guide may preferably be removable and exchangeable as the nut size may demand or in the alternative be fabricated for different nut sizes.

The drill bit guide of the present invention may preferably be fabricated from mild or hardened alloy steel to provide the sturdiness needed for use in construction, or other industrial settings.

### BRIEF DESCRIPTION OF THE DRAWINGS

FIG. 1 illustrates a perspective view of the drill bit guide showing the socket and nut portion according to the present invention.

FIG. 2 illustrates a top perspective view of the drill bit guide showing the hollow guide portion according to the present invention.

FIG. 3 illustrates a plate or substrate with a drill bit guide and a bolt head according to the present invention.

FIG. 4 illustrates a plate portion with a drill and drill bit on a bolt head according to the present invention.

FIG. 5 illustrates plate portion with a drill and drill bit with bolt shank separated from the head according to the present invention.

### DETAILED DESCRIPTION

In an embodiment of the present invention, a drill bit guide suitable for the removal of bolts, nuts and fasteners that are accessible from the nut end but without such access to the shank end. Also, nuts and bolts that may be too loose that addressing them for removal by unscrewing may not be practical. Those familiar in the art would typically utilize the overly intensive method of punching out the bolt in the center with a chisel and drilling a pilot hole followed by a hole that is a bit larger or wider in diameter than the shank of the bolt. Such process separates the bolt head from the shank but ends up with a larger hole, implying a reusable larger bolt for a replacement. In some instances, such holes may be abandoned, and new ones drilled out to meet the size of readily available bolts.

The time and energy to chisel out a bolt head and drill or punch through such shanks with the likelihood of creating larger diameter holes make for hard to remove bolts and may end up creating holes that need to be patched up to reduce the impact of the environment in rust and water damage prevention. Where these substrates are held together by fasteners, the routinized process for unscrewing or removing the bolts may include using a vice grip to clamp the shank end of the bolt, just to aid the unscrewing process. Where such fasteners are not tight or are loose, the process might include sheering off the bolt head or grinding up the ends to free the shank from the bolt or nut head. It is reasonable therefore to foresee and imagine difficulties in cutting off the bolt-hear; if grinders are used, the likelihood of fires or some unplanned sparks generating flames.

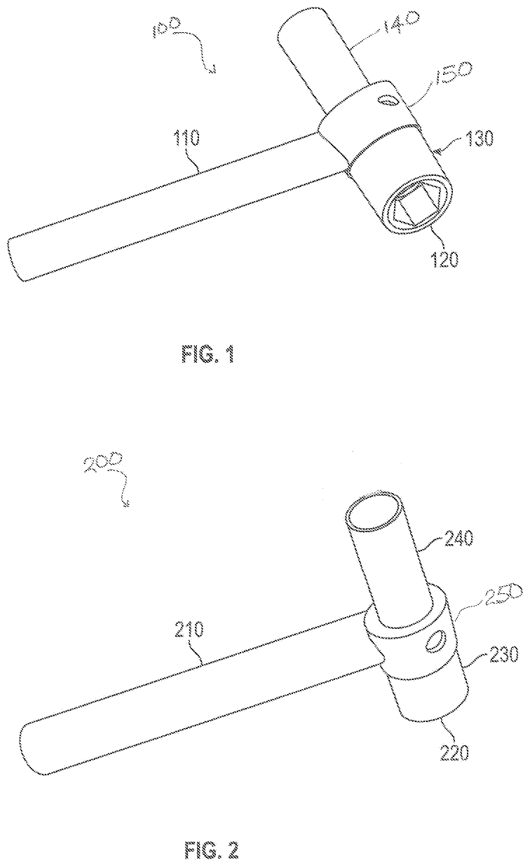

Referring to FIGS. 1 and 2, are presented, perspective views of a brill bit guide 100, 200 according to the instant disclosure. The drill bit guide 100, 200 of the present invention is preferably comprises a handle 110, 210 a socket 130, 230 or a set screw 120, 220, a guide for the screw 140, 240, and an adjustable grip 150, 250 for the socket. The drill bit guide 100, 200 of the present invention is preferably fabricated from mild or hardened alloy steel for the needed material strength as is usable for tools. The handle 110, 210 of the drill guide or tool is preferably of sufficient length to provide a user a portion to hold the tool with a firm enough grip portion. The handle 110, 210 is suitable to provide the socket when slotted over the bolt, such proper access as needed for the drill and such that the user may use for the drill to fit and position for the drilling target. It is also preferable that such material usable as a drill bit guide tool according to the present invention possess sturdiness to be durable for environments that may need hard hats and face protection as is typical of construction sites, welding shops, tool fabrication units, and the like. Given the many sizes of bolts and nuts that are used in industry, the socket 130, 230 of the present invention is preferably adaptable to provide centering of the drill bit on the bolt head through a variety of bolt specs. Although not graphically displayed, the socket 130, 230 or set screw 120, 220 of the present tool may be removeable or switchable such that one tool guide can be used for many nut and bolt sizes. Such adaptation may include having a universal grip 110, 210 that provides a latching mechanism to the guide portion 150, 250 which may be fabricated in a manner that allows for such replacement. In another embodiment, the socket or set screw, and guide portion may be made as a single tool, with many sizes made available for the adaptation and use.

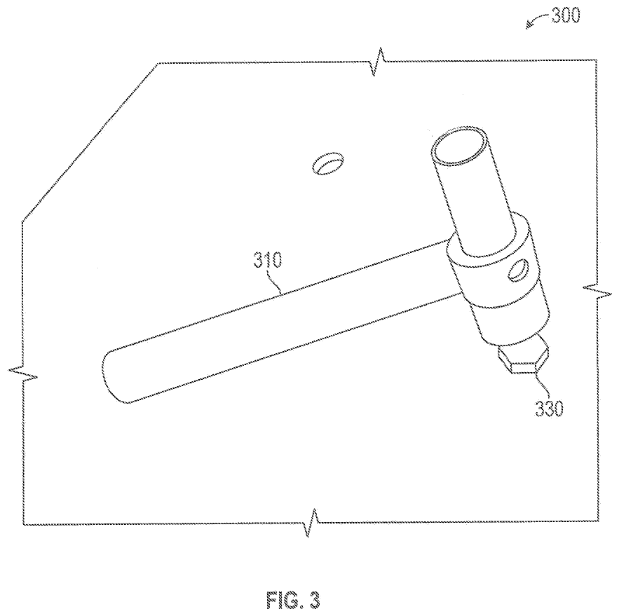

FIG. 3 presents the drill bit guide tool of the present invention on a typical plate 300 having at least one bolt or nut that is firmly attached to the substrate with limited access to the other end (side) of the substrate. Where the use of the drill bit guide is needed to remove the bolt or nut, the nut does not present itself in a manner suitable for unscrewing with a socket wrench, even with a vice grip on the shank side of the nut. A drill bit guide according to the present invention provides a tool suitable to guide the drill to the center of the head of the bolt, said guide having a guide hole 320 suitable for at least a drill bit as large in diameter as the shank of the bolt. This embodiment recognizes the many variations of nuts and bolts used in industry and applications for fastening items to substrates. The substrate or plate 300 illustrates at least a nut with a bolt head.

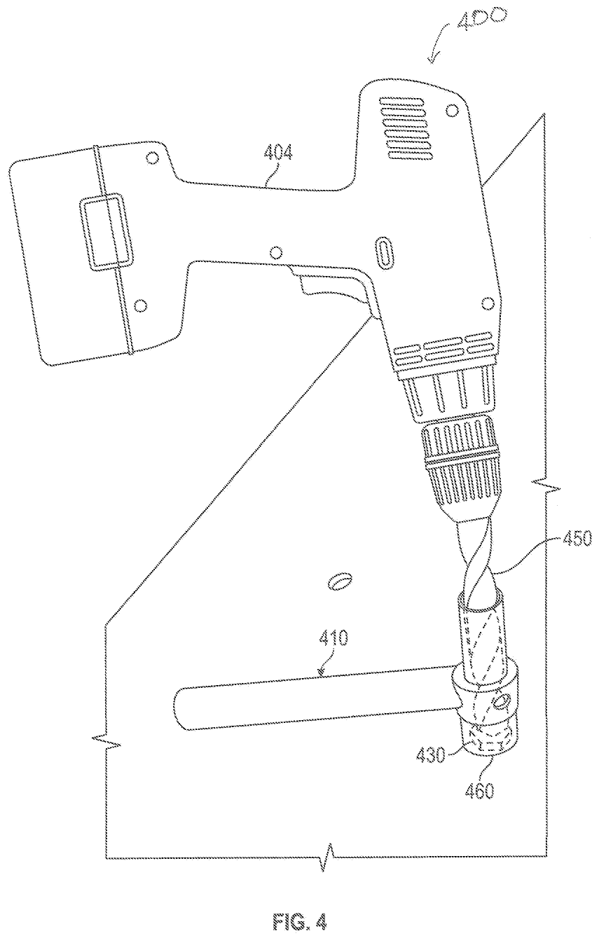

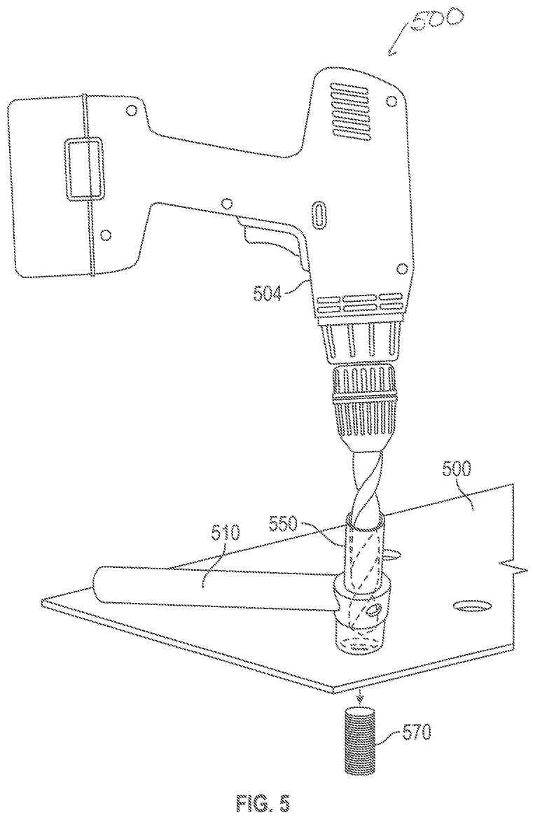

FIG. 4 depicts a substrate or plate 400 having as described above a bolt and nut that needs to be removed or unscrewed. A drill 404 is presented with a drill bit 450 channeled through the guide end 460 and illustrative of said drill bit 450 slotted and reaching to the head of the bolt 430, noting that the tool firmly holds such bolt head in a fixed position to prevent unintended rotation or spinning as the drill is powered. While not a part of the invention or the teaching of this disclosure, the drill 404 and the drill bit 450 should preferably be of such composition and makeup that can drill on the head of the bolt without doing damage (such as blunting) to the drill or lack the capacity to complete the drill and separation purpose of the set up.

FIG. 5 presents a disclosure of the drill bit in use by way of the guide tool to separate a bolt from the shank on a plate or such substrate where the shank portion although shown as accessible, was not easily reached as described above. The drill bit 550 drills through the diameter of the head a hole larger that the diameter of the bolt shank when powered by the drill 504 with an operator guiding with a grip 510 to prevent the bolt from spinning.

This embodiment may vitiate the need to create a bigger hole where the nut and bolt were used, prevents undue waste for substrates or plate surfaces that may have been condemned, provides access to the reverse side of such plates, saves time in the process of removing the bolt and nut, all in a clean process. The dangers of sparks and fires are mitigated by the use of the tool of the present disclosure.

The combination of the drill with a drill bit, and the drill bit guide of the present invention provides a product for use in removing or unscrewing a nut with a bolt head and shank portion. The process of separating a nut with a bolt head from the shank portion includes inserting the drill having a drill bit into the hollow and open portion of the drill bit guide further enough for an open end of the drill bit end to contact the bolt head of the nut and drilling that bolt head to cause is to separate from the shank of the nut. The practicality of this use is preferably shown when access to the shank portion is not feasible or the nut is loose.

In some combination to remove the bolt from the shank, the drill bit guide is used on bolts that have a fastener or such fastening tool is incorporated to prevent the bolt or nut from turning loosely.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed:

1. A drill bit guide, comprising:
a handle
wherein said handle is suitable to provide a firm grip for a drill bit guide with centering on a bolt head;
a guide having a first and second end;
wherein the first end is hollow and suitable for insertion and guiding of a drill bit, and a second end having a socket or set screw, and further wherein the set screw or socket end of the guide is adaptable to fit a bolt head or securely hold a fastener;
wherein the centering of the hollow portion and the screw portion fit and guide a drill bit on to the bolt head by use of the socket and screw;
wherein in use, the drill can operably be utilized to separate the bolt head from a shank portion of a bolt.

2. The drill bit guide of claim 1, wherein the combination of the drill bit and guide is suitable to remove fastened bolts where access to the shank portion of the bolt or screw are limited.

3. The drill bit guide of claim 1, wherein the drill bit guide is formed from mild or hardened alloy steel.

4. The drill bit guide of claim 1, wherein the screw guide is provided with a fastener to prevent the bolt from turning freely.

5. A method of removing a bolt and screw, comprising:
utilizing a drill bit guide
wherein said drill bit guide comprises a handle
wherein said handle is suitable to provide a firm grip for a drill bit guide with centering on a bolt head;
a guide having a first and second end;
wherein the first end is hollow and suitable for insertion and guiding of a drill bit, and a second end having a socket or set screw, and further wherein the set screw end of the guide is adaptable to fit a bolt head;
wherein the centering of the hollow portion and the screw portion fit and guide a drill bit on to the bolt head by use of the socket and screw;
operating the drill bit guide to separate the bolt head from a shank portion of a nut and screw.
